(19) United States
(12) Patent Application Publication
(10) Pub. No.: US 2025/0018820 A1
(43) Pub. Date: Jan. 16, 2025

(54) CHARGING AND DISCHARGING CONTROL SYSTEM

(71) Applicant: Changchun Jetty Automotive Technology Co., Ltd., Jilin (CN)

(72) Inventors: Chao WANG, Jilin (CN); Yun MIAO, Jilin (CN)

(21) Appl. No.: 18/714,551

(22) PCT Filed: Nov. 23, 2022
(86) PCT No.: PCT/CN2022/133664

§ 371 Date: May 29, 2024

(30) Foreign Application Priority Data
Nov. 30, 2021 (CN) 202122966236.9

(51) Int. Cl. B60L 53/66; H02J 7/00

(52) U.S. Cl. CPC B60L 53/66; H02J 7/007186

(57) ABSTRACT

A charging and discharging control system, including a charging control box and a charging gun. The charging control box includes a control module, a communication module, a charging port, a discharging port, and a first controllable switch circuit. The charging gun includes a charging resistor, a discharging resistor, and a second controllable switch circuit. The control module is signal-connected to the first controllable switch circuit, the second controllable switch circuit, and the communication module, and the control module is configured to, in a state where the charging port is connected to the power grid and based on battery status information of the electric automobile, control the first controllable switch circuit to switch to be connected to the charging port, and control the second controllable switch circuit to switch to be connected to the charging resistor.

The present application is a National Stage Entry of International Application No. PCT/CN2022/133664, filed Nov. 23, 2022, and claims priority to Chinese Patent Application No. 202122966236.9, entitled “CHARGING AND DISCHARGING CONTROL SYSTEM”, and filed on Nov. 30, 2021, the disclosures of which are incorporated herein by reference in their entireties.

### TECHNICAL FIELD

The present disclosure relates to the technical field of new-energy electric automobile, and in particular to a charging and discharging control system.

### BACKGROUND

With the rapid development of the automobile industry and the increasing awareness of environmental protection among people, the development of the new-energy automobile industry has become a key point in addressing the shortage of petroleum resources and reducing atmospheric pollution. Charging piles equipped are also a type of necessary device.

Charging piles may be mounted in charging stations of public buildings (for example, public premises, shopping malls, and public parking lots) and charging stations of residential community parking lots, and they can charge various models of electric automobiles based on different voltage levels. Of the charging piles, an input terminal is directly connected to alternating current power grid, and an output terminal is equipped with a charging plug for charging an electric automobile. In case of emergencies such as power grid shortage or power grid breakdown, existing charging piles are unable to operate. A massive number of electric automobiles, which serve a type of mobile distributed energy storage devices, store a significant amount of electrical energy. Therefore, how to effectively utilize the electrical energy of idle electric automobiles is the problem that needs to be addressed at present.

### SUMMARY

To resolve the foregoing technical problem, the present disclosure provides a charging and discharging control system, including:
a charging control box, which includes a control module, a communication module, a charging port, a discharging port, and a first controllable switch circuit, and the first controllable switch circuit is configured to achieve switching between the charging port and the discharging port, the charging port is used to be connected to a power grid, the discharging port is used to be connected to an external electrical device, and the communication module is configured to achieve communication connection between the control module and an electric automobile; and
a charging gun, which includes a charging resistor, a discharging resistor, and a second controllable switch circuit, and the second controllable switch circuit is configured to achieve switching between the charging resistor and the discharging resistor;
and the control module is signal-connected to the first controllable switch circuit, the second controllable switch circuit, and the communication module, and the control module is configured to, in a state where the charging port is connected to the power grid and based on battery status information of the electric automobile,
control the first controllable switch circuit to switch to be connected to the charging port, and control the second controllable switch circuit to switch to be connected to the charging resistor, so that a charging loop is formed to enable the charging gun to output an alternating voltage or alternating current being matched with a battery of the electric automobile.

The charging and discharging control system provided by the present disclosure can charge the electric automobile and also allows the electric automobile to supply power to an electric device, meeting the charging and discharging requirements for the electric automobile in different scenarios.

To make the above and other objectives, features, and advantages of the present disclosure more comprehensible, exemplary embodiments are described below in detail with drawings.

### BRIEF DESCRIPTION OF THE DRAWINGS

To describe the technical solutions in the embodiments of the present disclosure or in the prior art more clearly, the drawings to be used in the description of the embodiments or the prior art will be briefly described below. Obviously, the drawings in the following description merely show some embodiments of the present disclosure, and a person of ordinary skill in the art may still derive other drawings from these drawings without inventive efforts.

FIG. 1 shows a charging and discharging control system according to Embodiment 1 of the present disclosure.

FIG. 2 shows a charging and discharging control system according to Embodiment 2 of the present disclosure.

### DESCRIPTION OF THE EMBODIMENTS

The technical solutions of the embodiments of the present disclosure are clearly and completely described below with reference to the drawings of the embodiments of the present disclosure. Obviously, the described embodiments are merely some rather than all of the embodiments of the present disclosure. All other embodiments obtained by those of ordinary skill in the art based on the embodiments of the present disclosure without inventive efforts shall fall within the protection scope of the present disclosure.

It should be noted that the terms “first”, “second”, and the like in the present disclosure, claims, and the foregoing drawings are used to distinguish between similar objects rather than to describe a specific order or sequence. It should be understood that the data used in this way is interchangeable in appropriate circumstances so that the embodiments of the present disclosure described herein can be implemented in other orders than the order illustrated or described herein. In addition, the terms “include”, “have”, and any variations thereof are intended to encompass non-exclusive inclusion. For example, a process, method, apparatus, product, or device that includes a list of steps or units is not necessarily limited to those steps or units clearly listed, but may include other steps or units which are not expressly listed or inherent to such process, method, apparatus, product, or device.

### Embodiment 1

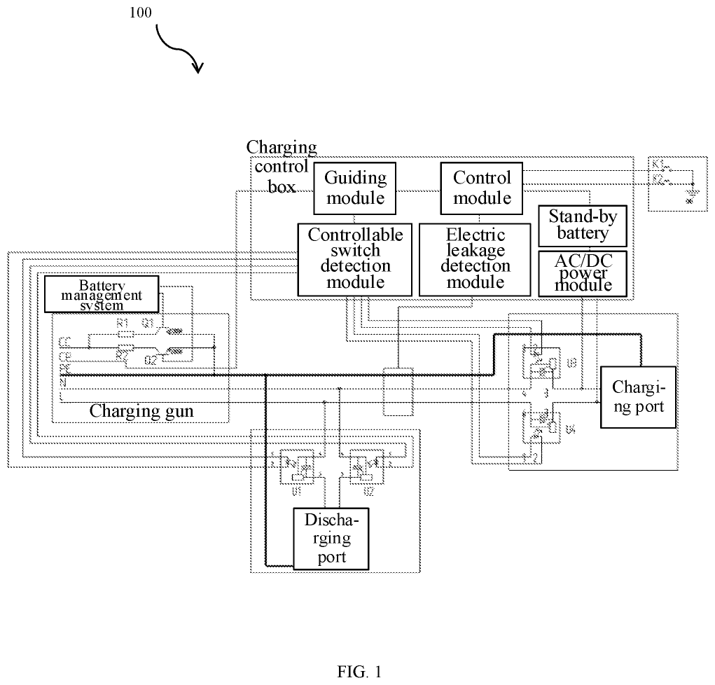

Referring to FIG. 1, this embodiment provides an exemplary alternating charging and discharging control system 100, including a charging control box and a charging gun.

Specifically, the charging control box includes a control module, a communication module (not shown in the figure), a charging port, a discharging port, and a first controllable switch circuit. The control module may be an MCU or a micro control unit. It can be understood that the communication module may be a GPRS (General Packet Radio Service) communication module, a WIFI module, or a Bluetooth module, and the GPRS communication module may be a 4G module or a 5G module. The first controllable switch circuit is configured to achieve switching between the charging port and a discharging port, the charging port is used to be connected to a power grid, the discharging port is used to be connected to an external electrical device, and the communication module is configured to achieve communication connection between the control module and an electric automobile.

The charging gun includes a charging resistor R1, a discharging resistor R2, and a second controllable switch circuit. The second controllable switch circuit is configured to achieve switching between the charging resistor R1 and the discharging resistor R2.

The control module is signal-connected to the first controllable switch circuit, the second controllable switch circuit, and the communication module, and the control module is configured to, in a state where the charging port is connected to the power grid and based on battery status information of the electric automobile,
control the first controllable switch circuit to switch to be connected to the charging port, and control the second controllable switch circuit to switch to be connected to the charging resistor R1, so that a charging loop is formed to enable the charging gun to output an alternating voltage or alternating current being matched with a battery of the electric automobile.

Further, the control module may be further configured to, in a state where the charging port is not connected to the power grid and the external electrical device is connected to the discharging port and based on the battery status information, control the first controllable switch circuit to switch to be connected to the discharging port, and control the second controllable switch circuit to switch to be connected to the discharging resistor R2, so that a discharging loop is formed to enable the charging gun to output an alternating current being matched with the power grid.

Thus, as the control module controls the first controllable switch circuit and the second controllable switch circuit, the charging and discharging control system according to this embodiment can charge the electric automobile with the alternating current power of the power grid and also allows the electric automobile to supply power to an electric device, meeting the charging and discharging requirements for the electric automobile in different scenarios.

Specifically, referring to FIG. 1, the first controllable switch circuit may include a first solid-state switch U1, a second solid-state switch U2, a third solid-state switch U3, and a fourth solid-state switch U4. Certainly, it can be understood that in this embodiment, the solid-state switch may be configured as a solid-state relay switch. In another embodiment, the solid-state switch of the first controllable switch circuit may be also replaced with a thyristor switching device and the like based on actual circuit arrangement requirements, to achieve the similar functions. This is not limited in the present disclosure.

The first solid-state switch U1 is connected between a live wire L of the charging gun and a neutral wire N of the discharging port; the second solid-state switch U2 is connected between a neutral wire N of the charging gun and a live wire L of the discharging port; the third solid-state switch U3 is connected between the neutral wire N of the charging gun and a neutral wire N of the charging port; and the fourth solid-state switch U4 is connected between the live wire L of the charging gun and a live wire L of the charging port.

More specifically, the second controllable switch circuit may include a first transistor Q1 and a second transistor Q2. A base electrode of the first transistor Q1 is configured to be connected to a battery management system of the electric automobile, a collector of the first transistor Q1 is connected to the charging resistor R1, another end of the charging resistor R1 is connected to a power supply voltage, and an emitter of the first transistor Q1 is connected to a ground wire of the charging gun; and a base electrode of the second transistor Q2 is configured to be connected to the battery management system of the electric automobile, a collector of the second transistor Q2 is connected to the discharging resistor R2, and an emitter of the second transistor Q2 is connected to the ground wire of the charging gun.

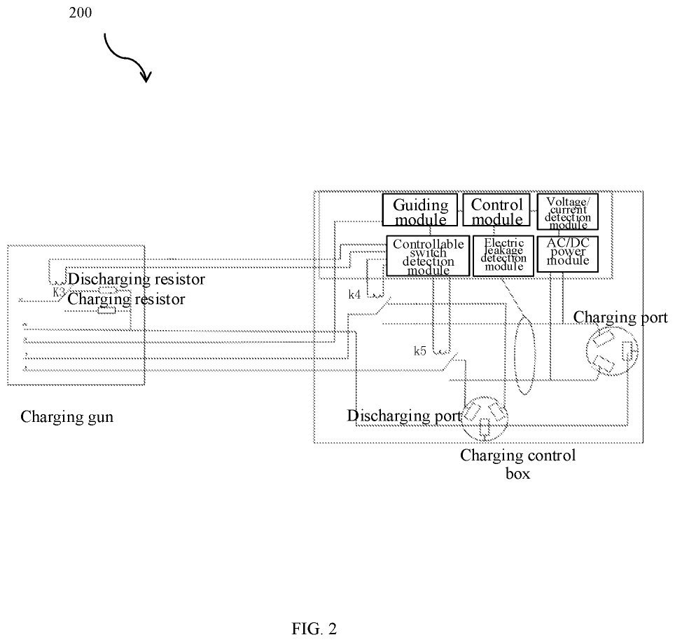

Therefore, in a state where the charging port is connected to the power grid, when the charging gun is not connected to the electric automobile, the AC (Alternating current)/DC (Direct current) power module obtains power for operation and outputs energy to a guiding module, a control module, a controllable switch detection module, an electric leakage detection module, a voltage/current detection module (referring to FIG. 2), such that each module prepares to operate.

Then, because the charging port is connected to the power grid, the control module detects that the alternating current power of the mains electricity is connected, the first transistor Q1 of the charging gun is conducted, and the charging resistor R1 is connected to a charging circuit, waiting for charging.

Before charging, the guiding module is also controlled to determine whether the electric automobile need to be charged. If it does, the electric leakage detection module is controlled to determine if there is an electric leakage abnormality. If there is no abnormality, the control module waits for the charging gun to be inserted into the electric automobile. The charging gun is connected to a charging port of the electric automobile, and the guiding module can detect the charging status and the connection status. If there is no abnormality, the guiding module notifies the control module that the charging preparation is complete and charging can begin. Then, the control module allows the controllable switch detection module to be connected to the third solid-state switch U3 and the fourth solid-state switch U4, so that a charging loop is formed to charge.

Certainly, it can be understood that if an abnormality occurs during electric leakage detection process, a prompting module can be alarmed and the control module can initiate emergency measures to prevent charging.

During discharging, because the charging port is not connected to the power grid and the charging port changes from being powered to losing power, the AC/DC power module loses power, the charging control box can be powered by the stand-by battery, the first transistor Q1 is disconnected, the second transistor Q2 is conducted, and the discharging resistor R2 is connected, waiting for discharging. It can be understood that the stand-by battery is electrically connected to the control module and used to supply power to the control module in a state where the charging port is not connected to the power grid. During charging, the AC/DC power module that has obtained power can charge the stand-by battery, and therefore in a state where the AC/DC power module loses power, it can be powered by the stand-by battery.

More specifically, before discharging, the guiding module is further controlled to determine whether the electric automobile has a discharging capability. If it does, the control module allows the controllable switch detection module to be connected to the first solid-state switch U1 and the second solid-state switch U2, so that a discharging loop is formed to discharge. After discharging to preset power, the first solid-state switch U1 and the second solid-state switch U2 can be controlled to disconnect.

Exemplarily, a charging selection button K1 and a discharging selection button K2 may be also provided outside the charging control box, the charging selection button K1 and the discharging selection button K2 are connected to the control module, and the control module is configured to control switching between the first controllable switch circuit and the second controllable switch circuit based on triggering of the charging selection button K1 or the discharging selection button K2.

It can be understood that the control module may not need to determine whether the power grid is connected to the charging port and whether the electric automobile is connected to the discharging port, and the charging mold or discharging mold may be selected by the user. This can improve the charge-discharge efficiency.

### Embodiment 2

Referring to FIG. 2, a charging and discharging control system 200 provided by this embodiment is different from the charging and discharging control system 100 in Embodiment 1 only in the specific configuration of the first controllable switch circuit and the second controllable switch circuit. Therefore, for brevity of description, only the different technical features are described in detail in this embodiment.

Specifically, as shown in FIG. 2, the first controllable switch circuit includes a first mechanical switch K4 and a second mechanical switch K5. A movable contact of the first mechanical switch K4 is connected to a neutral wire N of the charging gun, a normally-closed contact of the first mechanical switch K4 is connected to a neutral wire N of the discharging port, and a normally-opened contact of the first mechanical switch K4 is connected to a neutral wire N of the charging port. A movable contact of the second mechanical switch K5 is connected to a live wire L of the charging gun, a normally-closed contact of the second mechanical switch K5 is connected to a live wire L of the discharging port, and a normally-opened contact of the second mechanical switch K5 is connected to a live wire L of the charging port.

Correspondingly, the second controllable switch circuit includes a third mechanical switch K3, a movable contact of the third mechanical switch K3 is connected to a battery management system of the electric automobile, a normally-closed contact of the third mechanical switch K3 is connected to the discharging resistor R2, and a normally-opened contact of the third mechanical switch K3 is connected to the charging resistor R1.

It can be understood that the mechanical switch in this embodiment may be configured as a mechanical relay switch.

Therefore, in a state where the charging port is connected to the power grid, in this case, the charging gun is not connected to the electric automobile, the AC/DC power module obtains power for operation and provides energy to a guiding module, a control module, a controllable switch detection module, an electric leakage detection module, and a voltage/current detection module, such that each module prepares to operate.

Then, the third mechanical switch K3 switches to the charging resistor R1 at the fastest speed, and the charging resistor R1 is connected to the charging circuit, waiting for charging.

Before charging, the guiding module is also controlled to determine whether the electric automobile need to be charged. If it does, the electric leakage detection module is controlled to determine if there is an electric leakage abnormality. If there is no abnormality, the control module waits for the charging gun to be inserted into the electric automobile. The charging gun is connected to a charging port of the electric automobile, and the guiding module can detect the charging status and the connection status. If there is no abnormality, the guiding module notifies the control module that the charging preparation is complete and charging can begin. Then, the control module allows the controllable switch detection module to control the first mechanical switch K4 and the second mechanical switch K5 to be attracted. In this case, the first mechanical switch K4 and the second mechanical switch K5 are connected to the charging port, so that a charging loop is formed to charge. It can be understood that the first mechanical switch K4 and the second mechanical switch K5 are connected to the discharging port by default, and therefore, they need to be attracted for switching to a charging process.

Certainly, it can be understood that if an abnormality occurs during electric leakage detection process, a prompting module can be alarmed and the control module can initiate emergency measures to prevent charging.

During discharging, because the charging port is not connected to the power grid and the charging port changes from being powered to losing power, the AC/DC power module loses power. Therefore, the modules such as the control module do not operate, and the first mechanical switch K4, the second mechanical switch K5, and the third mechanical switch K3 are not conducted. That is, the default state is restored. In this state, the first mechanical switch K4 and the second mechanical switch K5 are connected to the discharging port, and the third mechanical switch K3 is connected to the discharging resistor R2, so that a discharging loop is formed to discharge.

More specifically, before discharging, the guiding module may be further controlled to determine whether the electric automobile has a discharging capability. If it does, discharging is performed.

It may be also understood that as long as the charging port does not obtain power, the AC/DC power module does not obtain power, the controllable switch detection module does not obtain power, the first mechanical switch K4, the second mechanical switch K5, and the third mechanical switch K3 do not attract (i.e., in the default state), the discharging port is connected to a discharging device of the electric automobile, and the electric automobile can output an alternating current of 220 V.

The charging and discharging control system of the embodiments of the present disclosure can charge the electric automobile and also allows the electric automobile to supply power to an electric device, meeting the charging and discharging requirements for the electric automobile in different scenarios.

Unless otherwise defined, technical and scientific terms used in the present disclosure have the same meaning as commonly understood by those skilled in the art of the present disclosure. The terms used in the present disclosure are merely for describing specific embodiments and not intended to limit the present disclosure. The terms such as “component” mentioned in the present disclosure may be individual parts or combinations of a plurality of parts. The terms such as “mount” and “provide” used in the present disclosure may mean a component is directly attached to another component or that a component is attached to another component through an intermediate component. In the present disclosure, the features described in one implementation can be applied separately or in combination with other features to another implementation, unless the feature is not applicable in the another implementation or there are other indications.

The present disclosure has been described through the above implementations; but it should be understood that these implementations are provided for exemplary and illustrative purposes and do not intend to limit the present disclosure in the range of the described implementations. Those skilled in the art can understand that based on the concept of the present disclosure, further variations and modifications can be made, all of which fall within the scope of protection required by the present disclosure.

1. A charging and discharging control system, comprising:
a charging control box, which comprises a control module, a communication module, a charging port, a discharging port, and a first controllable switch circuit, wherein the first controllable switch circuit is configured to achieve switching between the charging port and the discharging port, the charging port is used to be connected to a power grid, the discharging port is used to be connected to an external electrical device, and the communication module is configured to achieve communication connection between the control module and an electric automobile; and
a charging gun, which comprises a charging resistor, a discharging resistor, and a second controllable switch circuit, wherein the second controllable switch circuit is configured to achieve switching between the charging resistor and the discharging resistor;
wherein the control module is signal-connected to the first controllable switch circuit, the second controllable switch circuit, and the communication module, and the control module is configured to, in a state where the charging port is connected to the power grid and based on battery status information of the electric automobile,
control the first controllable switch circuit to switch to be connected to the charging port and control the second controllable switch circuit to switch to be connected to the charging resistor, so that a charging loop is formed to enable the charging gun to output an alternating voltage or alternating current being matched with a battery of the electric automobile.

2. The charging and discharging control system according to claim 1, wherein the control module is further configured to, in a state where the charging port is not connected to the power grid and the external electrical device is connected to the discharging port and based on battery status information,
control the first controllable switch circuit to switch to be connected to the discharging port and control the second controllable switch circuit to switch to be connected to the discharging resistor, so that a discharging loop is formed to enable the charging gun to output an alternating current being matched with the power grid.

3. The charging and discharging control system according to claim 2, wherein the first controllable switch circuit comprises a first mechanical switch and a second mechanical switch, a movable contact of the first mechanical switch is connected to a neutral wire of the charging gun, a normally-closed contact of the first mechanical switch is connected to a neutral wire of the discharging port, and a normally-opened contact of the first mechanical switch is connected to a neutral wire of the charging port; and
a movable contact of the second mechanical switch is connected to a live wire of the charging gun, a normally-closed contact of the second mechanical switch is connected to a live wire of the discharging port, and a normally-opened contact of the second mechanical switch is connected to a live wire of the charging port.

4. The charging and discharging control system according to claim 2, wherein the first controllable switch circuit comprises a first solid-state switch, a second solid-state switch, a third solid-state switch, and a fourth solid-state switch, wherein
the first solid-state switch is connected between a live wire of the charging gun and a neutral wire of the discharging port;
the second solid-state switch is connected between a neutral wire of the charging gun and a live wire of the discharging port;
the third solid-state switch is connected between the neutral wire of the charging gun and a neutral wire of the charging port; and
the fourth solid-state switch is connected between the live wire of the charging gun and a live wire of the charging port.

5. The charging and discharging control system according to claim 2, wherein the second controllable switch circuit comprises a third mechanical switch, a movable contact of the third mechanical switch is connected to a battery management system of the electric automobile, a normally-closed contact of the third mechanical switch is connected to the discharging resistor, and a normally-opened contact of the third mechanical switch is connected to the charging resistor.

6. The charging and discharging control system according to claim 2, wherein the second controllable switch circuit comprises a first transistor and a second transistor, wherein
a base electrode of the first transistor is configured to be connected to a battery management system of the electric automobile, a collector of the first transistor is connected to the charging resistor, another end of the charging resistor is connected to a power supply voltage, and an emitter of the first transistor is connected to a ground wire of the charging gun; and
a base electrode of the second transistor is configured to be connected to the battery management system of the electric automobile, a collector of the second transistor is connected to the discharging resistor, and an emitter of the second transistor is connected to the ground wire of the charging gun.

7. The charging and discharging control system according to claim 1, wherein the charging control box further comprises an AC/DC power module connected to an input terminal of the control module and configured to, in a state where the charging port is connected to the power grid, supply power to the control module.

8. The charging and discharging control system according to claim 1, wherein a charging selection button and a discharging selection button are also provided outside the charging control box, the charging selection button and the discharging selection button are connected to the control module, and the control module is configured to control switching between the first controllable switch circuit and the second controllable switch circuit based on triggering of the charging selection button or the discharging selection button.

9. The charging and discharging control system according to claim 1, wherein the charging control box is further provided with a stand-by battery, and the stand-by battery is electrically connected to the control module and configured to supply power to the control module in a case that the charging port is not connected to the power grid.

10. The charging and discharging control system according to claim 1, wherein the communication module is any one selected from a 5G module, a 4G module, a WIFI module, and a Bluetooth module.
